(19) United States
(12) Patent Application Publication
(10) Pub. No.: US 2016/0375643 A1
(43) Pub. Date: Dec. 29, 2016

(54) APPARATUS AND METHOD FOR MANUFACTURING COMPOSITE REINFORCEMENT STRUCTURE

(71) Applicant: Hyundai Motor Company, Seoul (KR)

(72) Inventors: Jeong Min Cho, Suwon-Gyeonggi-do (KR); Huen Sick Min, Hwaseong (KR); Chi Hoon Choi, Suwon (KR); Sang Yoon Park, Daejeon (KR); Dae Won Kim, Anyang (KR); June Ho Yang, Seoul (KR)

(21) Appl. No.: 14/977,762

(22) Filed: Dec. 22, 2015

(30) Foreign Application Priority Data
Jun. 29, 2015 (KR) 10-2015-0092332

(51) Int. Cl. B29C 70/52; B29C 70/20

(52) U.S. Cl. CPC B29C 70/525; B29C 70/20; B29C 70/521; B29K 2105/08

(57) ABSTRACT

Disclosed is a method for manufacturing a composite reinforcement member, comprising: an impregnation step of impregnating a resin into reinforcement fibers withdrawn from a plurality of creels; a non-uniform distribution step of passing the resin-impregnated reinforcement fibers through a guide to adjust spaces among the reinforcement fibers in such a manner that the reinforcement fibers are distributed at different densities per area according to regions of the cross section of the composite reinforcement member; a forming step of directing the reinforcement fibers into a mold from the guide; and a curing step of curing the resin impregnated into the reinforcement fibers emerging from the mold.

### CROSS REFERENCE TO RELATED APPLICATION

The present application claims priority of Korean Patent Application No. 10-2015-0092332 filed Jun. 29, 2015, the entire contents of which is incorporated herein for all purposes by this reference.

### BACKGROUND OF THE INVENTION

1. Field of the Invention

The present invention relates to an apparatus and a method for manufacturing a composite reinforcement member in which fibers are distributed at different densities per area of the cross section of the member, thus selectively reinforcing regions of interest.

2. Description of the Related Art

Among conventional techniques for forming a continuous fiber-reinforced composite structure having a defined cross section are impregnation methods by immersing reinforcement fibers in a liquid resin or spraying a resin at a high pressure.

In light of the property thereof, a reinforcement member does not require uniform strength across its entirety. However, conventional techniques have difficulty in selectively reinforcing regions of interest because of the uniform distribution of fibers within a forming step.

Fully considering the problem with conventional techniques, the present invention provides a method and apparatus for manufacturing a composite reinforcement member satisfactory to a given condition by adjusting spaces among fiber reinforcements to distribute the fiber reinforcements at different densities per area according to regions of the cross section of the member, thereby increasing the strength of a region of interest.

The matters described as the background arts are only intended to increase the understanding of the background of the present invention, but should not be recognized as being prior arts which are already known to those skilled in the art.

### SUMMARY OF THE INVENTION

In order to accomplish the above object, the present invention provides a method for manufacturing a composite reinforcement member, comprising: an impregnation step of impregnating a resin into reinforcement fibers withdrawn from a plurality of creels; a non-uniform distribution step of passing the resin-impregnated reinforcement fibers through a guide to adjust spaces among the reinforcement fibers in such a manner that the reinforcement fibers are distributed at different densities per area according to regions of the cross section of the composite reinforcement member; a forming step of directing the reinforcement fibers into a mold from the guide; and a curing step of curing the resin impregnated into the reinforcement fibers emerging from the mold.

In one embodiment of the present invention, the method may further comprise, after the non-uniform distribution step: a semi-curing step of curing 10˜20% of the resin of the fiber; and a drawing step of drawing the fibers.

In another embodiment of the present invention, the method may further comprise, after the curing step, a reinforcing step of depositing a layer of a fabric composed of fibers on the semi-cured member.

In another embodiment of the present invention, the method may further comprise, after the curing step, a processing step of cutting the semi-cured member into a predetermined size according to use.

In another embodiment of the present invention, the fibers withdrawn from the creels differ in tensile strength from one to another.

In another embodiment of the present invention, the fibers withdrawn from creels corresponding to regions where fibers are distributed at a high density are higher in tensile strength than are those withdrawn from creels corresponding to regions where fibers are positions at a low density.

According to another aspect thereof, the present invention provides an apparatus for manufacturing a composite reinforcement member, comprising: a resin impregnator for impregnating a resin into fibers; a guide for adjusting spaces among the fibers passing therethrough to distribute the fibers at different densities per area according to portions of the cross section of the reinforcement member; a mold for molding resin-impregnated fibers; and a resin hardener for curing the resin of the reinforcement fibers.

In one embodiment of the present invention, the apparatus may further comprise: a semi-curing device for curing 10˜20% of the resin of the fibers; and a drawing dies having an outlet smaller in size than an input.

In another embodiment of the present invention, the apparatus may further comprise a laminator for depositing a layer of a fabric composed of fibers on the semi-cured member.

In another embodiment of the present invention, the apparatus may further comprise a cutting blade for cutting the semi-product into a size according to use.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a top view of an apparatus for manufacturing a composite reinforcement member according to an embodiment of the present invention;

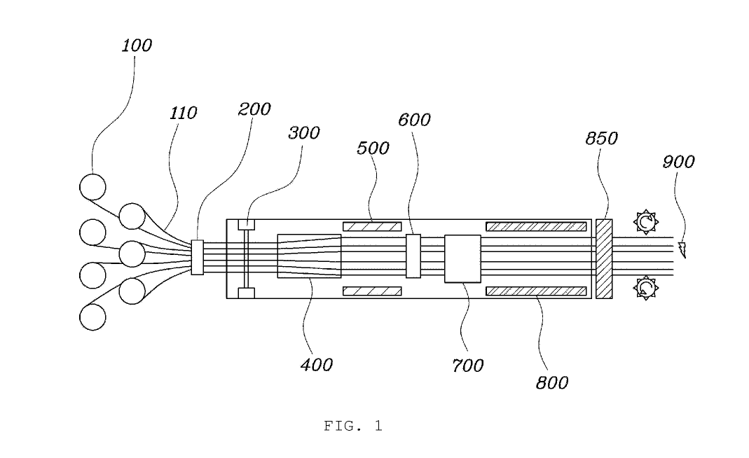

FIG. 2 shows a cross section of an inlet of a guide to which fibers are fed and a cross section of the guide through which the fibers travel;

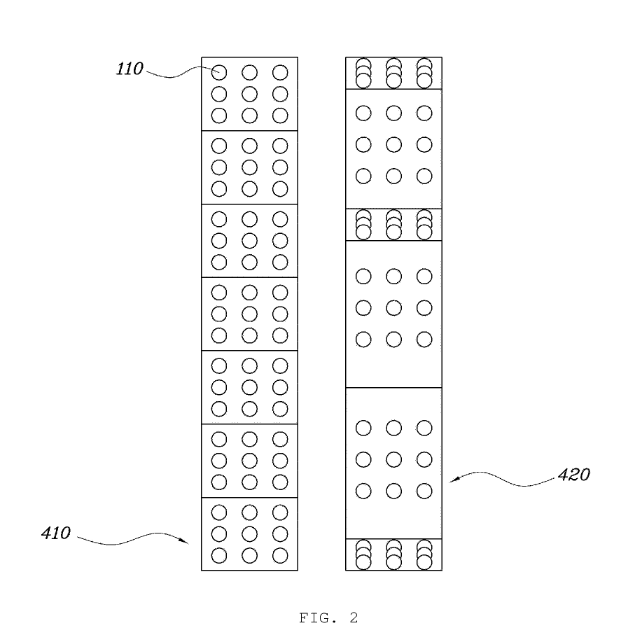

FIG. 3 is a mold according to an embodiment of the present invention;

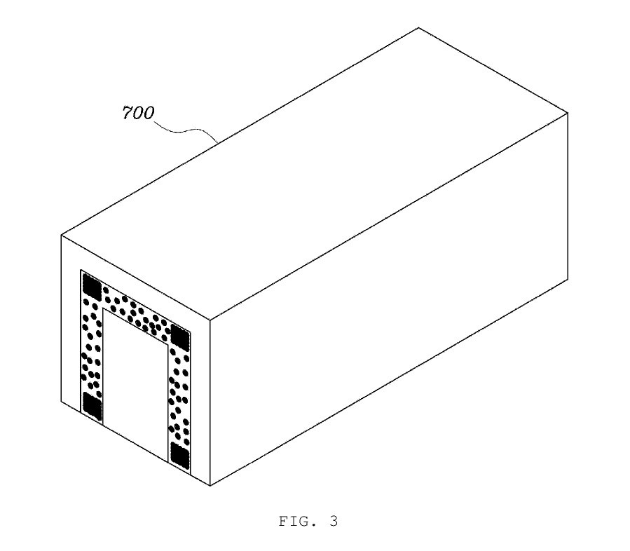

FIG. 4 is a view of a selectively reinforced reinforcement member; and

FIG. 5 is a view showing the distribution of selectively reinforced reinforcement members in an A-pillar.

### DESCRIPTION OF THE PREFERRED EMBODIMENTS

Hereinbelow, preferred embodiments of the present invention will be described in detail with reference to the accompanying drawings. In the following description, it is to be noted that, when the functions of conventional elements and the detailed description of elements related with the present invention may make the gist of the present invention unclear, a detailed description of those elements will be omitted.

In accordance with an aspect thereof, the present invention addresses a method for manufacturing a composite reinforcement member, comprising an impregnation step of impregnating a resin into reinforcement fibers 110 withdrawn from a plurality of creels 100; a non-uniform distribution step of passing the resin-impregnated reinforcement fibers 110 through a guide 400 to adjust spaces among the reinforcement fibers 110 in such a manner that the reinforcement fibers 110 are distributed at different densities per area according to regions of the cross section of the composite reinforcement member; a forming step of directing the reinforcement fibers 110 into a mold 700 from the guide 400; and curing the resin impregnated into the reinforcement fibers 110 emerging from the mold 700.

The present invention relates to the manufacture of a composite structure member, characterized by a process of impregnating a resin into fibers 100 withdrawn from a plurality of creels 100, forming the fibers after a shape of the composite structure member, and curing the resin. This manufacturing method is advantageous in the forming and producing of a structural member having a certain cross sectional shape.

Examples of the resin impregnated into the fibers 110 include epoxy, polyester, vinyl ester, and polyamide.

The guide 400 is adapted to distribute fibers. In the non-uniform distribution step, the resin impregnated fibers 110 are non-uniformly positioned so as to make a fiber density per area of the cross section perpendicular to the fiber passing direction of the guide 400 different according to regions across the cross section, thereby allowing for the manufacture of a composite structure member in which the fibers 110 are locally distributed at different densities.

Functioning to improve the stability of a structure, a reinforcement member is typically applied to a site of the structure that requires strength and rigidity due to the concentration of external impacts thereon. Hence, the reinforcement member also receives the external impacts to extents that are different from one region of the member to another.

A reinforcement member produced by a conventional drawing process has fibers 110 that are uniformly distributed across the cross section thereof, and thus is not selectively reinforced according to regions thereof. In the present invention, however, a fiber density per area can be adjusted according to regions to reinforce a region of interest, thereby resulting in a reinforcement member that is improved in stability.

In addition, fewer fibers can be localized in regions that require relatively low strength and rigidity. Thus, a given resource can be efficiently utilized, with the resultant reduction of production cost.

Using a mold 700 having a predetermined cross section, a plurality of the reinforcement fibers 110 is formed to have a corresponding, desired cross section. For example, when the mold 700 has a curved cross section, the impregnated fibers 110 are formed into a member having a corresponding cross section. If impacts are concentrated on the curved region of the reinforcement member, it should be manufactured to have a high density of the fibers at the curved region.

After the forming step, the resin applied to the fibers 110 is cured to complete the manufacture of the composite structure member. The curing may be implemented at room temperature or using a high-temperature, high-pressure press. In terms of productivity, the use of the high-temperature, high-pressure press is advantageous.

The technical core spirit of the present invention is to provide a method for manufacturing a composite reinforcement member that is locally reinforced by distributing a higher density of fibers 110 at a region requiring higher strength and rigidity.

After the non-uniform distribution step, the method may further comprise a semi-curing step of curing the resin of the fiber 110 by 10˜20%; and a drawing step of drawing the fibers 110. The semi-curing step and the drawing step may be conducted subsequently or concurrently. In the Example section of the present invention, a description is made of the case where fibers are semi-cured while being drawn and compressed.

For drawing the resin-impregnated fibers 110 with the use of a drawing dies 600 and compressing the drawn fibers, the impregnation of resin and the volume ratio should be improved. Prerequisite to this improvement is a semi-curing step of resin. This is because when the resin impregnated into the plurality of fibers 110 is not cured to some degree, it is highly likely to flow due to its low viscosity during passage through the drawing dies 600 in the drawing step.

In the semi-curing step, the curing is preferably conducted to a degree of 10˜20%. For example, when the curing degree is below 10%, the resin is likely to be removed during the drawing process. On the other hand, when the curing degree exceeds 20%, formability becomes poor so that the cross section is difficult to form into a desired shape. In addition, at a curing degree of 20% or less, the resin can be remolded and formed on the fabric layer composed of reinforcement fibers by re-heating.

Control is made of the temperature of the resin during the semi-curing step so that the resin impregnated into the plurality of reinforcement fibers is maintained at a low viscosity before the forming step. For an epoxy resin with a curing temperature of above 180° C., for example, the temperature at which the semi-curing step is conducted is adjusted into about 80˜85° C. to maintain the viscosity of the resin at a low level, thus guaranteeing the formability of the resin. The temperature to be controlled varies depending on the kind of resin.

In the drawing dies, the temperature is elevated and controlled. At an elevated temperature, the resin becomes low in viscosity, and is compressed when it moves toward the outlet of the drawing dies because the dies narrow into the outlet. In this course, the removal of the fiber-distributing guide may avoid the formation of voids and gaps in the product. After the drawing step, that is, just prior to the forming step, the temperature is controlled to maintain the viscosity of the resin impregnated into the plurality of reinforcement fibers at a low level, thereby maximizing the formability of the plurality of the reinforcement fibers.

To achieve a curing degree of 10˜20%, first, a curing speed per hour under a certain condition should be measured. According to the measurement, the curing rate of the plurality of reinforcement fibers 110 is estimated in the drawing step, and then the curing range necessary for a curing degree of 10˜20% is preferably set.

In some embodiments of the present invention, a beam in which a layer of a fabric composed of supplement fibers is deposited entirely over the surface of the reinforcement fibers or locally on the surface of a portion to be reinforced may be obtained between the drawing step and the forming step. The beam may be applied to various car parts, such as a FEM (Front-end modules) carrier, a bumper beam, a door impact beam, etc.

Following the curing step, the method may further comprise a reinforcing step of depositing a layer of a fabric composed of fibers on the semi-cured member.

When deposited with the fabric layer, the reinforcing member composed of the resin and the fibers 110 will have further improved strength and rigidity. The fabric may be deposited entirely over the surface of the semi-cured member or locally on the surface of a portion to be reinforced.

After the curing step, the method may further comprise a processing step of cutting the semi-cured member into a predetermined size according to use.

All the semi-products thus obtained have the same cross section because they are formed through the same mold 700. When the semi-products are longer than the final composite reinforcement member, they may be cut into a plurality of composite reinforcement members having the same cross section, using a blade 900.

In another embodiment of the present invention, the fibers 110 withdrawn from the creels 100 may differ in tensile strength from one to another.

Reinforcement fibers withdrawn from creels 100 corresponding to regions where the reinforcement fibers are distributed at a high density are higher in tensile strength than are those withdrawn from creels 100 corresponding to regions where the reinforcement fibers 100 are positions at a low density.

Carbon fibers are higher in tensile strength, but more expensive than glass fibers. For manufacturing a functionally good composite reinforcement member at a limited cost, the use of inexpensive but low strength reinforcement fibers 110 in a region requiring relatively low tensile strength and the use of relatively expensive but high strength reinforcement fibers in a region requiring relatively high tensile strength is efficient.

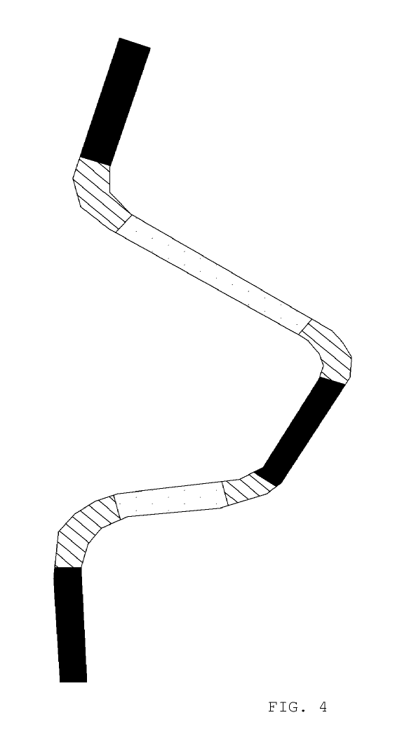

When a reinforcement member in accordance with an embodiment of the present invention is manufactured as shown in FIG. 4, it may be selectively reinforced in such a manner that carbon fibers are responsible for 60˜70% by volume of central and opposite end (black) regions that require high mechanical properties and for 40˜50% by volume of curved regions (slash lines), while the other regions (dotted) requiring relatively low properties are made of glass fibers.

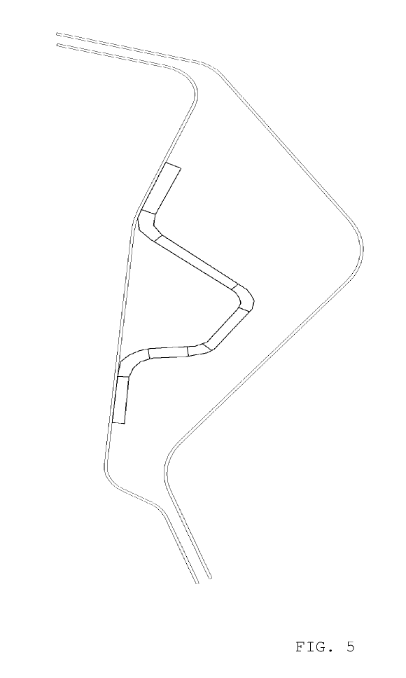

As shown in FIG. 5, the reinforcement members may be distributed inside an A-pillar.

According to the present invention, the composite reinforcement member is selectively reinforced where the reinforcement fibers are distributed at a high density in a region requiring high physical properties and at a low density in a region requiring relatively low physical properties.

Further, if reinforcement fibers 110 withdrawn from creels 100 corresponding to regions requiring the distribution of fibers at a high density per area are set to have a greater tensile strength than those withdrawn from creels 100 corresponding to a region requiring the distribution of fibers at a low density per area, selective reinforcement can be further brought about according to regions.

If employing glass fibers as reinforcement fibers 110 in a portion to be in contact with a steel member, the composite reinforcement member according to an embodiment of the present invention may be preventive of galvanic corrosion.

In accordance with another aspect thereof, the present invention addresses an apparatus for manufacturing a composite reinforcement member, comprising: a resin impregnator 300 for impregnating a resin into fibers 110; a guide 400 for adjusting spaces among the fibers 110 passing therethrough to distribute the fibers 110 at different densities per area according to portions of the cross section of the reinforcement member; a mold 700 for molding resin-impregnated fibers 110; and a resin hardener 800 for curing the resin of the reinforcement fibers 110.

For use as a reinforcement member, the fibers withdrawn from a plurality of creels 100 are coated with a resin that is then solidified. The composite reinforcement member obtained in this process has high strength and light weight. In addition, the composite reinforcement member is easy to manufacture.

The resin impregnator 300 is responsible for the impregnation of the fibers 110 with a resin. In one embodiment of the present invention, the fibers 110 may be immersed into and taken back from a bath containing the resin or the resin may be sprayed over the fibers 110.

A fiber distribution plate 200 for uniformly distributing the fibers 110 withdrawn from a plurality of creels 100 may be installed so that the fibers are allowed to pass through the fiber distribution plate 200 ahead of the resin impregnator 300. The fiber distribution plate (200) has a plurality of through-holes that are uniform in size and spaced at regular intervals so that the fibers 110 are distributed in the same pattern as the through-holes as they pass through the fiber distribution plate 200.

Serving to distribute the fibers 110 at different densities per area according to portions of the cross section of the reinforcement member by adjusting spaces among the fibers 110 passing therethrough, the guide 400 is an element essential for implementing the technical core spirit of the present invention.

A reinforcement member in which fibers 110 are uniformly distributed across the cross section thereof can be manufactured simply by impregnating the fibers withdrawn from a plurality of creels 100 with a resin and curing the resin. However, after passing through the guide for distributing fibers in a non-uniform manner, the impregnated fibers are divided into many bundles that differ in fiber density from each other.

The non-uniformly distributed fibers 110 are allowed to enter the mold 700 in which the member can be provided with a defined cross section. The mold is responsible for this function.

After being molded into a desired shape in the mold 700, the fibers 110 exist in the resin. Then, the resin is completely cured by the resin curer 800.

In another embodiment of the present invention, the apparatus may further comprise a roller by which fibers 110 can be continuously withdrawn from a plurality of creels 100 and run through the resin impregnator 300, the guide, and the resin curer 800.

In another embodiment of the present invention, the apparatus may further comprise a semi-curing device 500 for curing 10˜20% of the resin of the fibers 110; and a drawing dies 600 having an outlet smaller in size than an input. The semi-curing device 500 and the drawing dies 600 may be provided as separate components, or as a single component by incorporating a heating device into the drawing dies 600.

To further increase the differentiation of fiber densities, the non-uniformly distributed fibers can be directed toward a drawing process. However, the resin may be peeled off during passage through the drawing device 600 when the resin remains unhardened. Hence, the resin should be cured to some degree.

In this context, the resin is 10˜20% cured using the semi-curing device 500. When the curing degree is below 10%, the resin is likely to be removed during the drawing process. On the other hand, when the curing degree exceeds 20%, formability becomes poor so that the cross section is difficult to form into a desired shape.

In another embodiment of the present invention, the apparatus may further comprise a laminator 850 for depositing a layer of a fabric composed of fibers on the semi-cured member.

When deposited with the fabric layer, the reinforcing member composed of the resin and the fibers 110 will have further improved strength and rigidity. The laminator 850 is responsible for this role, and the region on which the fabric is deposited may vary depending on the setting.

In another embodiment of the present invention, the apparatus may further comprise a cutting blade for cutting the semi-product into a suitable size.

When the semi-products are longer than the final composite reinforcement member, they may be cut into a plurality of composite reinforcement members having the same cross section, using a blade 900.

The semi-products may be cut into a plurality of composite reinforcement members having the same cross section, using a blade 900.

As described hitherto, the apparatus and method for manufacturing a composite reinforcement member composite in accordance with the present invention makes it possible to distribute reinforcement fibers at different densities per area according to regions of the cross section of the composite reinforcement member, so that the composite reinforcement member can be selectively reinforced. In addition, a given resource can be efficiently utilized, with the resultant reduction of production cost.

Further, a fiber density per area can be adjusted according to regions to reinforce a region of interest, thereby resulting in a reinforcement member that is functionally improved, compared to conventional members.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for manufacturing a composite reinforcement member, comprising:
an impregnation step of impregnating a resin into reinforcement fibers withdrawn from a plurality of creels;
a non-uniform distribution step of passing the resin-impregnated reinforcement fibers through a guide to adjust spaces among the reinforcement fibers in such a manner that the reinforcement fibers are distributed at different densities per area according to regions of the cross section of the composite reinforcement member;
a forming step of directing the reinforcement fibers into a mold from the guide; and
a curing step of curing the resin impregnated into the reinforcement fibers emerging from the mold.

2. The method of claim 1, further comprising, after the non-uniform distribution step:
a semi-curing step of curing 10˜20% of the resin of the fiber; and
a drawing step of drawing the fibers.

3. The method of claim 1, further comprising, after the curing step, a reinforcing step of depositing a layer of a fabric composed of fibers on the semi-cured member.

4. The method of claim 1, further comprising, after the curing step, a processing step of cutting the semi-cured member into a predetermined size according to use.

5. The method of claim 1, wherein the fibers withdrawn from the creels differ in tensile strength from each other.

6. The method of claim 5, wherein the fibers withdrawn from creels corresponding to regions where fibers are distributed at a high density are higher in tensile strength than are those withdrawn from creels corresponding to regions where fibers are positions at a low density.

7. An apparatus for manufacturing a composite reinforcement member, comprising:
a resin impregnator for impregnating a resin into fibers;
a guide for adjusting spaces among the fibers passing therethrough to distribute the fibers at different densities per area according to portions of the cross section of the reinforcement member;
a mold for molding resin-impregnated fibers; and
a resin hardener for curing the resin of the reinforcement fibers.

8. The apparatus of claim 7, further comprising:
a semi-curing device for curing 10˜20% of the resin of the fibers; and
a drawing dies having an outlet smaller in size than an input.

9. The apparatus of claim 7, further comprising a laminator for depositing a layer of a fabric composed of fibers on the semi-cured member.

10. The apparatus of claim 7, further comprising a cutting blade for cutting the semi-product into a size according to use.
